(19) United States
(12) Patent Application Publication
(10) Pub. No.: US 2024/0159265 A1
(43) Pub. Date: May 16, 2024

(54) LINEAR FLEXURE BEARINGS HAVING NON-UNIFORM THICKNESS, AND SYSTEMS AND METHODS FOR USING AND MAKING THE SAME

(71) Applicant: Teledyne FLIR Commercial Systems, Inc., Goleta, CA (US)

(72) Inventors: Andreas Fiedler, Santa Barbara, CA (US); Nathan T. Paszek, Goleta, CA (US)

(21) Appl. No.: 18/420,656

(22) Filed: Jan. 23, 2024

Related U.S. Application Data
(63) Continuation of application No. PCT/US2022/037909, filed on Jul. 21, 2022.
(60) Provisional application No. 63/226,630, filed on Jul. 28, 2021.

(51) Int. Cl. F16C 11/12; F16C 29/00

(52) U.S. Cl. CPC F16C 11/12; F16C 29/008

(57) ABSTRACT

A system includes a linear flexure bearing including an integral one-piece plate. The plate has a first portion, a second portion surrounding the first portion, and a flexing region between the first and second portions. At least one of the first and second portions is thicker than the flexing region. Other features are also provided.

### CROSS REFERENCE TO RELATED APPLICATIONS

This application is a continuation of International Patent Application No. PCT/US2022/037909 filed Jul. 21, 2022 and entitled “LINEAR FLEXURE BEARINGS HAVING NON-UNIFORM THICKNESS, AND SYSTEMS AND METHODS FOR USING AND MAKING THE SAME,” which claims priority to and the benefit of U.S. Provisional Patent Application No. 63/226,630 filed Jul. 28, 2021 and entitled “LINEAR FLEXURE BEARINGS HAVING NON-UNIFORM THICKNESS, AND SYSTEMS AND METHODS FOR USING AND MAKING THE SAME,” all of which are incorporated herein by reference in their entirety.

### BACKGROUND

The present invention relates to linear flexure bearings.

Linear flexure bearings reduce or eliminate wear and friction in seals between parts moving linearly relative to each other, such as between a piston and piston housing. This disclosure relates to new flexure bearings, systems using such flexure bearings, and methods of using and making such flexure bearings and systems.

### SUMMARY

This section summarizes some features of the invention. Other features may be described in the subsequent sections. The invention is defined by the appended claims, which are incorporated into this section by reference.

A system is provided that includes a first linear flexure bearing comprising an integral one-piece plate. The plate has a first portion, a second portion surrounding the first portion, and a flexing region between the first and second portions. At least one of the first and second portions is thicker than the flexing region.

A system is provided that includes a linear flexure bearing assembly extending generally along a plane when no bending force is applied to the linear flexure bearing assembly. The linear flexure bearing assembly comprises: a first portion; a second portion surrounding the first portion and movable relative to the first portion when a bending force is applied transversal to the plane to flex the linear flexure bearing assembly; and a flexing region comprising a plurality of membranes each of which extends generally along the plane between the first portion and the second portion, and each membrane flexes when the bending force is applied to the assembly. At least one membrane is made of a continuous medium which continues into at least one of the first and second portions, and continues within the at least one of the first and second portions transversely to the membrane to protrude out of a plane of the membrane.

A method is provided, the method comprising: obtaining a plate having a uniform thickness; and processing the plate to form a linear flexure bearing, wherein the processing comprises forming a flexing region in the plate, wherein forming the flexing region comprises forming one or more cavities to thin the plate at a location of the flexing region, the flexing region being thinner than a maximal thickness of the linear flexure bearing.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 includes perspective and cross-sectional views of a flexure bearing and a stack of flexure bearings according to some embodiments of the present disclosure.

FIG. 2 is a cross sectional view of a flexure bearing according to some embodiments of the present disclosure.

FIGS. 3 and 4 are cross sectional views of a piston assembly with a flexure bearing.

FIG. 5 is a flowchart of a flexure bearing manufacturing process according to some embodiments of the present disclosure.

FIGS. 6 and 7 are cross sectional views of flexure bearings according to some embodiments of the present disclosure.

FIG. 8 is a schematic view of a stack of flexure bearings according to some embodiments of the present disclosure.

FIG. 9 is a cross sectional view of a cryocooler compressor assembly with flexure bearing stacks according to some embodiments of the present disclosure.

Embodiments of the present invention and their advantages are best understood by referring to the detailed description that follows. It should be appreciated that like reference numerals are used to identify like elements illustrated in one or more of the figures.

### DETAILED DESCRIPTION

The embodiments described in this section illustrate but do not limit the invention. The invention is defined by the appended claims.

A linear flexure bearing can be formed as a thin metal disk, of a sub-millimeter thickness (e.g. 0.7 mm), and can be used to provide a seal between a piston and piston housing. The piston is attached to the disk center, and the housing to the disk periphery (rim). When the piston moves relative to the housing, the disk center is displaced axially relative to the rim, but the disk has a high radial stiffness, possibly hundreds or thousands of time higher than the axial stiffness, and the high radial stiffness restricts the piston side motion to prevent the piston from contacting the housing. A precise, narrow seal is maintained between the piston and the housing. Therefore, flexure bearings are superior to sliding bearings with regard to performance and to device lifetime.

In order to provide low stiffness in the axial direction, the flexure bearing includes cuts between the center portion and the rim, to form flexing arms extending between the center portion and the rim.

Flexure bearings can be implemented in stacks to increase the radial stiffness if needed to support the side forces, i.e. the forces pushing the piston against the housing. The side forces can be generated by gravity, magnetic actuation, or other phenomena. Because the stack may allow for significant axial motion, the flexure bearings need to be spaced from each other within the stack to prevent their arms from touching each other. Traditionally, such spacing was achieved by spacers inserted between individual flexures at the center and the rim. See for example U.S. Pat. No. 6,813,225, issued Nov. 2, 2004 to Widdow son et al., incorporated herein by reference.

The inventors have observed that as the number of spacers and flexures grows in a stack, alignment can become a concern. Some embodiments of the present disclosure help to improve the alignment in the stack by integrating a flexure with at least one spacer to form a single integral part, reducing the sum of the alignment tolerances. The flexure is thick at the center and the rim, and is thin between the center and the rim. Use of such flexures reduces part count, helping to improve cost and assembly time for the flexure and the system using the flexure.

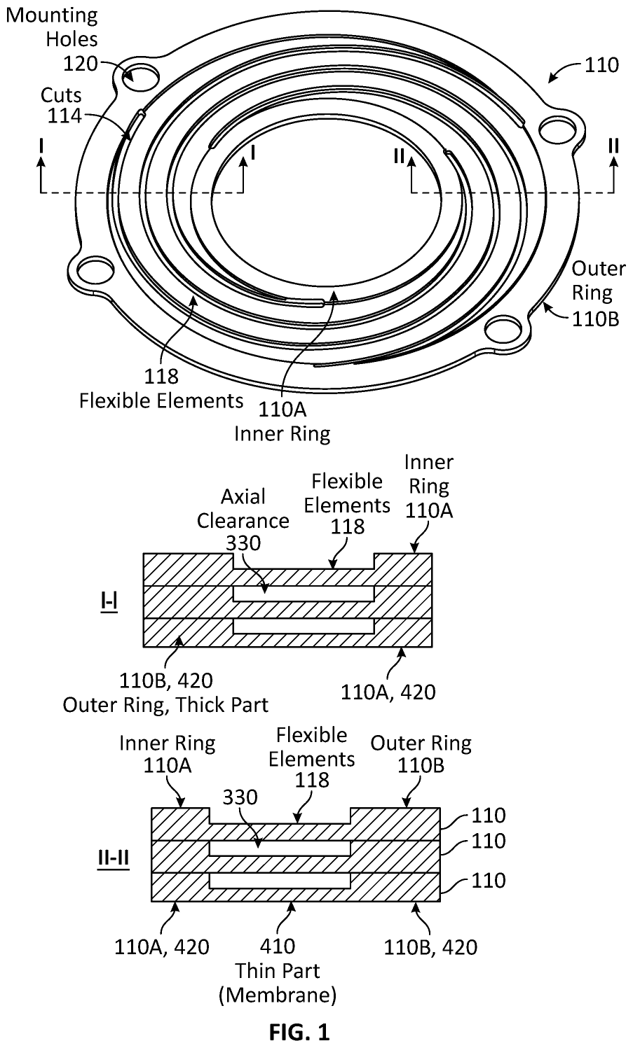

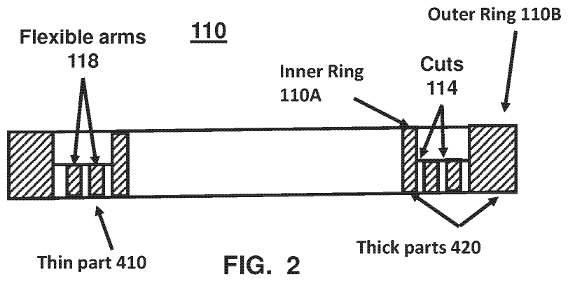

Exemplary flexures 110 are illustrated in FIGS. 1 and 2. FIG. 1 shows, at the top, a perspective view of a single flexure 110; and shows at the bottom two vertical cross sections marked I-I and II-II. The vertical cross sections illustrate a stack of three flexures 110 of the kind shown at the top of FIG. 1. The I-I and II-II cross sections are taken at diametrically opposite sides of the ring-shaped flexure 110. The I-I and II-II cross sections are shown on a larger scale than the perspective view at the top of FIG. 1. Flexure cuts 114 are not shown in cross sections I-I and II-II for simplicity. FIG. 2 shows a cross section of a single flexure 110.

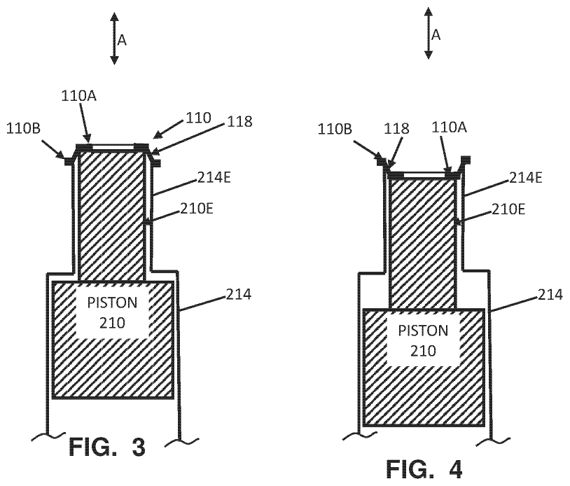

Flexure 110 is a thin metal plate. The flexure's inner portion 110A can be rigidly attached to a piston 210 (FIGS. 3, 4), and more particularly to piston extension (piston rod) 210E. The flexure's outer portion 110B can be rigidly attached to piston housing 214, and more particularly to housing extension 214E. In FIGS. 1 and 2, the flexure plate is shaped like a disk, and the inner and outer portions 110A and 110B are ring-shaped, but other shapes are possible, e.g. rectangular shapes for attachment to a rectangular (parallelepiped) piston 210.

Flexure 110 includes cuts (kerfs) 114 running from inner portion 110A to outer portion 110B to form flexure arms 118 between the cuts. Flexure 110 can flex in the axial direction, which is transversal (e.g. perpendicular) to the plane of flexure 110, e.g. the direction A in FIGS. 3 and 4. Flexure 110 has very high stiffness in the radial direction (the direction along the flexure plane) to support side forces. The radial stiffness can be hundreds or thousands of times greater than the axial stiffness.

FIG. 3 shows the piston position such that the inner ring 110A is above the outer ring 110B; FIG. 4 shows the piston position such that inner ring 110A is below the outer ring 110B. Piston 210 reciprocates between the two positions in the A direction.

Flexure 110 includes mounting holes 120 at outer portion 110B for attachment to piston housing or other parts. The flexure may also include mounting holes in inner portion 110A for attachment to pistons or other parts. Mounting holes can be absent as other types of attachment, e.g. clamps, solder, welding, etc., are possible.

As noted above, flexure bearings can be implemented in stacks to increase the radial stiffness. When implemented in a stack, their arms 118 should not touch each other. Rather than using separate spacers, flexure 110 is made thicker at locations where spacers may otherwise be desirable. For example, the inner and outer portions 110A, 110B can be thicker than the flexing region of flexure arms 118. In this embodiment, the bottom side of each flexure 110 is planar (as in FIG. 1), but the top side has a cavity (a recess) at the location of flexible arms 118. The flexure thus includes a thin part 410 (a membrane) at the cavity location, and thick parts 420 everywhere else. In some embodiments, the thin part 410 includes the flexing region 118, and may cover additional area, i.e. possibly extending into inner portion 110A and/or outer portion 110B. In other embodiments, the thin part 410 does not cover the entire area of arms 118. Thin part 410 may or may not extend into inner portion 110A and/or outer portion 110B beyond the cuts 114.

The adjacent flexures 110 physically contact each other at thick parts 420 but not at thin flexing regions 118 (the regions of flexure arms 118). In some embodiments, the thick parts 420 of adjacent flexures are attached to each other by solder or other adhesive, and the thick parts 420 are spaced from each other due to the adhesive layer therebetween, but the axial clearance between adjacent thick parts 420 (the adhesive thickness) is smaller than axial clearance 330 (FIG. 1) between adjacent thin flexing regions 118.

The flexure dimensions can be chosen to prevent the adjacent flexing regions 118 from contacting each other during the axial displacement of inner portion 110A relative to outer portion 110B. In an exemplary embodiment, the thin part 410 is ring-shaped, concentrically with rings 110A and 110B, and includes only flexing region 118, i.e. does not extend into the inner and outer rings 110A, 110B.

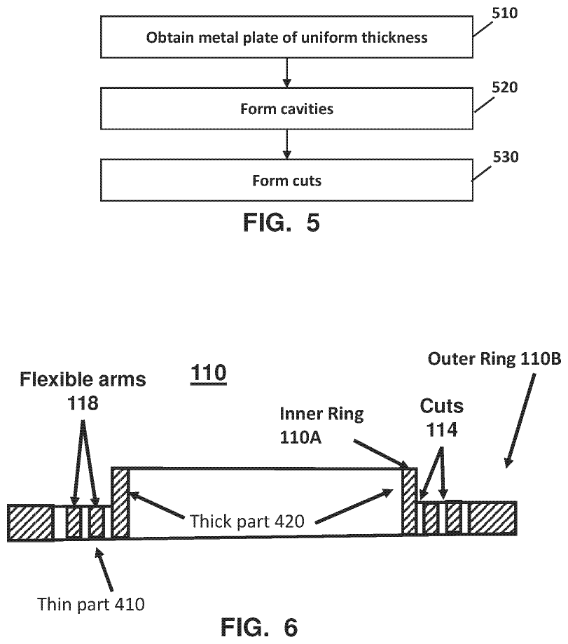

In some embodiments, each flexure 110 is an integral, one-piece structure fabricated of metal, e.g. spring steel. FIG. 5 illustrates a fabrication process. Fabrication starts at 510 with a plate of uniform thickness. Then (520) the cavities are formed in the plate by photo-chemical etching, to create thin part 410. Then (step 530) cuts 114 are formed. In some embodiments, cuts 114 are formed in the thin part 410 only. In other embodiments, cuts 114 extend into a thick part 420. Cuts 114 may also be formed before the cavities, i.e. operation 530 may be performed before 520. Other fabrication processes can also be used.

Thus, in some embodiments, the entire flexure is made of the same continuous material, or is made of multiple layers of possibly different materials which merge together to form a continuous medium for the flexing operation. In some embodiments, all the layers are metal. In some embodiments, the flexure is a crystalline material, e.g. metal, possibly a single crystal. The invention is not limited to particular materials or fabrication processes.

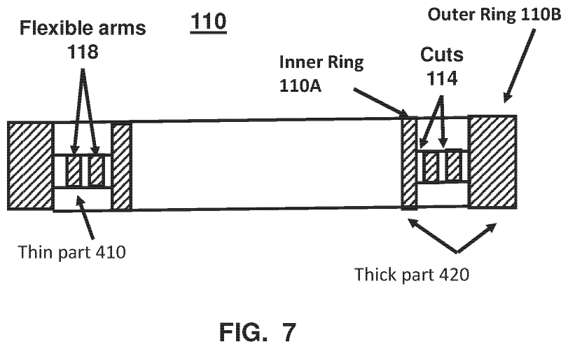

In FIG. 6, a thick portion 420 is provided at inner ring 110A but not at outer ring 110B. Spacers can be used at the outer ring when stacking the flexure bearings. In other embodiments, the thick portion is provided at outer ring 110B but not at inner ring 110A.

As illustrated in FIG. 7, a thick part 420 can protrude both upward and downward relative to the thin part (membrane) 410. Such flexure 110 may be stacked with prior art flexures of uniform thickness without spacers between the prior art flexures and flexure 110. Such prior art flexures can be placed above and/or below the flexure 110.

More generally, flexures 110 can be stacked together with other flexures, including possibly prior art flexures, with or without spacers. For example, a prior art flexure can be stacked on top of flexure 110 of FIGS. 1 and 2, possibly without spacers if the clearance 330 (FIG. 1) is sufficient to prevent contact between the flexing region 118 and the flexing region of the prior art flexure. Separate spacers can be provided between some pairs of flexures, e.g. where the axial clearance 330 is missing or insufficient to prevent flexures from contacting each other.

Some embodiments include tangential and/or other flexure geometries such as disclosed in U.S. Pat. No. 5,492,313 issued Feb. 20, 1996 to Pan et al.; U.S. Pat. No. 6,813,225 issued Nov. 2, 2004 to Widdowson et al.; and U.S. patent publication no. 2015/0041619 A1 published Feb. 12, 2015 (inventors: Ellis et al.), all of which are incorporated herein by reference. Such flexure geometries, and other geometries, can be modified to include thicker parts 420 (FIGS. 1-7) as needed to provide flexing room for the flexing regions.

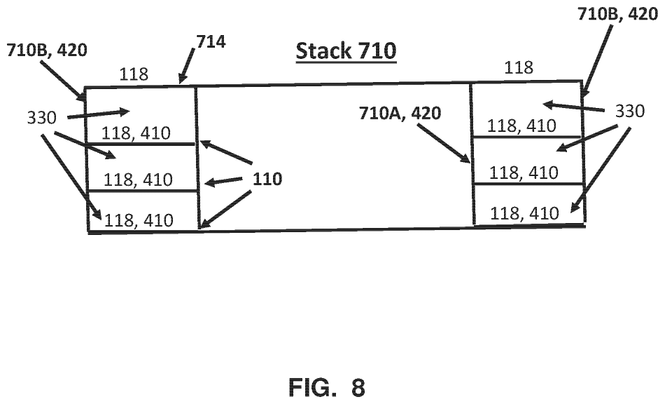

Any number of flexure bearings can be stacked in many possible ways. FIG. 8 is a schematic cross sectional view of an exemplary stack 710 of four flexure bearings. The top flexure bearing 714 is a conventional flexure of a uniform thickness, and the remaining three flexures 110 are as in FIGS. 1 and 2. The flexures 110 include thick parts 420 at inner and outer rings 110A, 110B. The inner rings of individual flexures join to form a stack inner ring 710A. The outer rings join to form a stack outer ring 710B. The stack inner and outer rings 710A, 710B include thick parts 420 of the bottom three flexures 110.

Each flexure 110 has a flexing membrane 118 which can be formed as a continuous medium merging with, and extending into, one or both of stack rings 710A, 710B. Inside each ring 710A and 710B, the continuous medium may extend up and/or down transversely to the membrane plane. Such extension protrudes up and/or down out of the membrane plane.

Top flexure bearing 714 can be omitted. Other variations are possible.

Flexure bearings of the present disclosure have a wide range of applications including in linear cryocoolers and other devices. In cryocoolers, the flexure bearings can reduce or eliminate wear in compressor and/or expander modules. Of note, the first cryo coolers with flexure bearings were Oxford type Stirling cryocoolers for space applications, where the flexure bearings were used in both the compressor and expander modules. The flexure bearings were later adopted for high performance tactical Stirling cryocooler designs, where the flexure bearings have been used almost exclusively in just the compressor module.

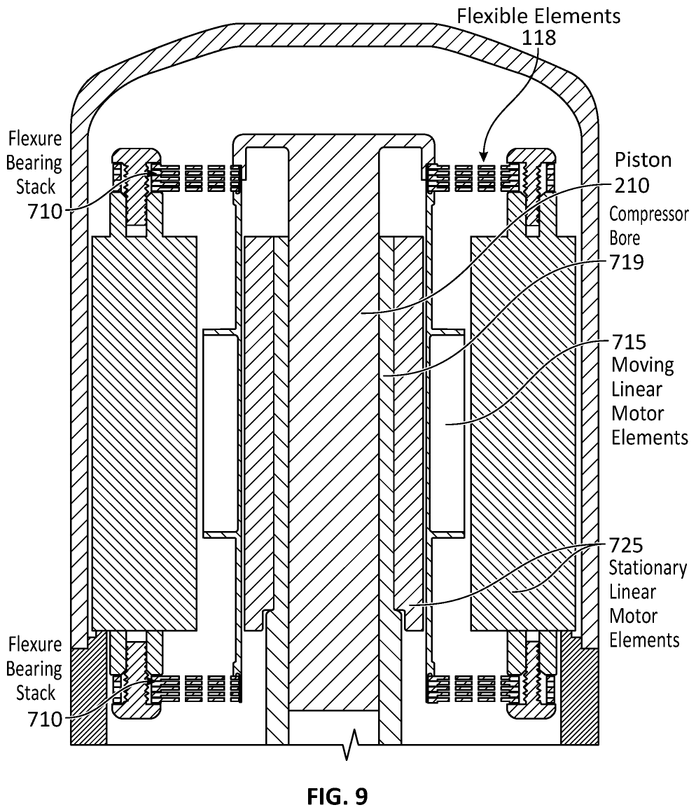

A cryocooler compressor example using flexures according to some embodiments of the present disclosure is shown in FIG. 9. A flexure bearing stack 710 is provided at each end of the compressor, i.e. the top and bottom ends in the view of FIG. 9 (but the compressor can operate in any spatial orientation). Each flexure bearing stack 710 can be any suitable stack discussed above, to couple the moving part of the compressor to the compressor stationary part. The moving part includes piston 210 and moving linear motor elements 715 of an electrical motor driving the piston. The moving linear motor elements 715 are rigidly connected to piston 210 to move together. The stationary part includes compressor bore 719 in which the piston reciprocates, and includes stationary linear motor elements 725.

Flexure bearing stacks 710 can be as in FIG. 8 or some other design. Each stack has an outer stack ring 710B (not marked in FIG. 9) rigidly attached to the compressor stationary part, and an inner stack ring 710A rigidly attached to the moving part of the compressor. Each flexure laterally surrounds the piston 210.

The invention is not limited to the embodiments described above. In particular, the invention is not limited to specific dimensions, materials, geometries, or other particulars. Flexure use is not limited to pistons. While the thickness of a flexure may have only two values—at thin part 410 and thick part 420, the thickness may vary over more than two values, e.g. different portions of thin part 410 or thick part 420 may differ in thickness. Further, the flexures may or may not be circular; for example, some flexure embodiments may be designed for non-circular pistons, e.g. for rectangular (parallelepiped-shaped) pistons. Other embodiments and variations are within the scope of the invention, as defined by the appended claims.

What is claimed is:

1. A system comprising:
a first linear flexure bearing comprising an integral one-piece plate;
wherein the plate comprises a first portion, a second portion surrounding the first portion, and a flexing region between the first and second portions; and
wherein at least one of the first and second portions is thicker than the flexing region.

2. The system of claim 1, wherein each of the first and second portions is thicker than the flexing region.

3. The system of claim 1, wherein the flexing region comprises one or more spiral arms each of which interconnects the first portion and the second portion.

4. The system of claim 1, wherein:
the plate comprises a first surface and a second surface opposite to the first surface; and
the first surface is recessed at the flexing region relative to the at least one of the first and second portions.

5. The system of claim 4, wherein the second surface does not have a recess.

6. The system of claim 4, wherein the second surface is recessed at the flexing region relative to the at least one of the first and second portions.

7. The system of claim 1, comprising:
a stack of a plurality of linear flexure bearings connected together and comprising the first linear flexure bearing and one or more additional linear flexure bearings;
wherein when no bending force is applied to the stack, a distance between: the flexing region of the first linear flexure bearing, and an adjacent linear flexure bearing in the stack, is greater than a distance between at least one of the first and second portions of the first linear flexure bearing and the adjacent linear flexure bearing.

8. The system of claim 1, comprising:
a stack of a plurality of linear flexure bearings connected together and comprising the first linear flexure bearing and one or more additional linear flexure bearings;
wherein each of the linear flexure bearings comprises a first portion, a second portion, and a flexing region between the first and second portions; and
wherein for at least two adjacent linear flexure bearings in the stack, a distance between the flexing regions is greater than at least one of a distance between the first portions and a distance between the second portions.

9. The system of claim 8, wherein for at least two adjacent linear flexure bearings in the stack, their first portions physically contact each other, and/or their second portions physically contact each other.

10. The system of claim 8, further comprising:
a linear motor;
a piston arranged to move within a bore; and
wherein the second portions are rigidly connected to a stationary part of the linear motor, and the first portions are rigidly connected to the piston.

11. The system of claim 10, wherein the piston is part of a cryocooler.

12. A system comprising:
a linear flexure bearing assembly extending generally along a plane when no bending force is applied to the linear flexure bearing assembly, the linear flexure bearing assembly comprising:
a first portion;
a second portion surrounding the first portion and movable relative to the first portion when a bending force is applied transversal to the plane to flex the linear flexure bearing assembly;
a flexing region comprising a plurality of membranes each of which extends generally along the plane between the first portion and the second portion, and each membrane flexes when the bending force is applied to the assembly; and
wherein at least one membrane is made of a continuous medium which continues into at least one of the first and second portions, and continues within the at least one of the first and second portions transversely to the membrane to protrude out of a plane of the membrane.

13. The system of claim 12, wherein the continuous medium continues into each of the first and second portions, and continues within each of the first and second portions transversely to the membrane to protrude out of the plane of the membrane.

14. The system of claim 12, wherein each membrane is made of a continuous medium which continues into at least one of the first and second portions, and continues within the at least one of the first and second portions transversely to the membrane to protrude out of a plane of the membrane.

15. The system of claim 12, wherein the continuous medium is thicker at at least one of the first and second portions than the membrane.

16. A method of using the system of claim 12, the method comprising applying the bending force by moving a piston connected to the first portion relative to a piston housing connected to the second portion.

17. A method of manufacturing the system of claim 1, the method comprising:
obtaining a first plate having a uniform thickness; and
processing the first plate to form the plate of the linear flexure bearing, wherein the processing comprises forming one or more cavities in the first plate at a location of the flexing region.

18. The method of claim 17, wherein the cavities are formed by photo-chemical etching.

19. A method comprising:
obtaining a plate having a uniform thickness; and
processing the plate to form a linear flexure bearing, wherein the processing comprises forming a flexing region in the plate, wherein forming the flexing region comprises forming one or more cavities to thin the plate at a location of the flexing region, the flexing region being thinner than a maximal thickness of the linear flexure bearing.

20. The method of claim 19, wherein the plate is made of metal, and at least one of the cavities is created by photo-chemical etching of the plate.
